(19) United States
(12) Patent Application Publication
(10) Pub. No.: US 2019/0034138 A1
(43) Pub. Date: Jan. 31, 2019

(54) METHODS AND SYSTEMS FOR MERGING AN INPUT DOCUMENT ON A MODIFIED BACKGROUND FORM

(71) Applicant: XEROX CORPORATION, Norwalk, CT (US)

(72) Inventors: Arindam Das, Konnagar (IN); Ramesh Pagoti, Srikakulam (IN); Ranita Bej, Kolkata (IN)

(21) Appl. No.: 15/482,854

(22) Filed: Apr. 10, 2017

(51) Int. Cl. G06F 3/12

(52) U.S. Cl. CPC G06F 3/1243; G06F 3/1208; G06F 3/1297; G06F 3/1275; G06F 3/1206

(57) ABSTRACT

The present disclosure discloses methods and systems (such as a printing system) for merging an input document on a modified background form. The method includes receiving a print job from a user device accessible by a user, wherein the print job includes the input document. The print job is decomposed to determine whether a background form is selected by the user for modification. Based on determination, the stored background form is extracted. Then, a selection input from the user is received via a user interface. The background form is modified based on the selection input. Finally, the modified background form is merged with the input document to generate a print document.

### TECHNICAL FIELD

The present subject matter relates generally to printing systems and more particularly to methods and systems for merging an input document on a modified background form for network printing.

### BACKGROUND

Printing industry is rapidly adopting automated workflow processes, including processes that allow users or customers to electronically submit input documents from user devices for inclusion into production data stored at printing systems. Examples of user devices may include workstations, personal computers, personal digital assistants (PDAs), laptop computers, notebooks, smart phones, and the like. The user devices can directly communicate with the printing systems, or can communicate with the printing systems over a network.

At the printing systems, the production data is received in a page description language (PDL) document before the receipt of the input document from the user devices and based on production specification present in the PDL document, the production data is rasterized and stored in raster format. The production data includes an electronic document or a background form (background raster form) defined by the PDL document. The background form includes a static template that defines a predetermined area in which the input document received from any one of the user devices can fit. In other words, the static template may represent the predetermined area in such a way that the input document should fit in a layout of a physical printed document. For example, in case of a background form for a utility bill, a generic static template is used in which predetermined areas are provided for receiving customer specific details from the input document incoming from the user devices.

Some of the techniques for embedding digital watermarks as background forms into the input document are discussed in U.S. Pat. No. 7,889,884 B2 (Feb. 15, 2011) and U.S. Pat. No. 7,006,256 B2 (Feb. 28, 2006). However, embedding a digital pattern such as digital watermarks into the input document, regardless of image process conditions for processing the input document, may cause degradation in image quality of final printed document. Watermark is a kind of image or text embedded in a document behind the main content. Examples of the watermarks may include Draft, Confidential, Preview, customized text and the like. While, background is considered as a color or a picture that also appears behind the main content in the document. For example, any picture, texture, patterns, or solid colors can be used as the background. The background enhances the appearance of the document, while the watermark protects the main content of the document and they are significantly different from each other. The concept of watermark and background is known in the art and thus, can be referred to.

In process, a user can submit a print job in the form of page description language (PDL) document from any of the user devices connected to the network. The PDL document may include information about fonts, graphics, and the like that describe the appearance of an input document, which is to be printed, present within the print job, and include a set of programming language commands or specifications for processing the input document based on the information. The print job can be submitted either by using a printer driver or by using a driverless web-based platform. The printer driver is normally associated with only one printer; however, the web-based platform is normally associated with a printing system communicatively coupled to all the network printers connected to the network.

Upon receipt of the print job, the printing system performs raster image processing on the input document. The raster image processing is a process of converting the input document into one or more print images, rasterizing pixel data of the print images into pixel values, and arranging the pixel values in an input raster buffer in raster format. Examples of the raster format may include, but not limited to, JPEG, TIFF, RAW, PNG, GIF, BMP, PPM, PGM, PBM, XBM, ILBM, WBMP, and PNM.

The input raster buffer is then merged or overlaid in at predetermined areas present with a background raster buffer, which corresponds to a background form or background raster form already available with the printing system. As a result of the merging, the printing system generates a merged raster buffer. The merged raster buffer is then converted into a ready-to-print (RTP) format and made available to the printer for generating a physical printed document.

However, while the merging the input raster buffer and the background raster buffer, the user of the user device is deprived of any option of editing or modifying the background form or background raster form on which the input document has to be merged, in order to cater the emerging requirement of customized background form for various personal, business, or administrative purposes. For example, there can be requirements where the user wants to merge specific background data with the input document but this seems difficult to achieve with the current solutions.

In this regard, one solution for modifying the background image is described in U.S. Pat. No. 6,771,391 B1 (Aug. 3, 2004). In that patent, the background image is modified by adjustment made to the gradation values (light density) of pixels of the background image, whereby the background image is made lighter so that a main image merged with the background image becomes denser relatively. Such modification merely provides emphasis on the main image and nothing more than that. Therefore, there exists a need for methods and systems for creating a modified background form and merge that modified background with the input document.

### SUMMARY

According to aspects illustrated herein, a method for merging an input document on a modified background form is disclosed. The method includes receiving, at a printing system, a print job from a user device accessible by a user. The print job includes an input document. Upon receipt of the print job, the print job is decomposed to determine whether a background form is selected by the user for modification. Based on determination, background form stored at the printing system is extracted and a selection input from a user is received for modification of the background form. In one example, the selection input includes selection of one or more region of interests or selection of one or more object types in the background form. Based on the selection input, the background form is modified and merged with the input document to generate a print document.

According to aspects illustrated herein, a printing system for merging an input document on a modified background form is disclosed. The printing system includes a processor, a digital front end module coupled to the processor. The digital front end module is configured to: receive a print job comprising the input document; present a background form at a user interface, of the printing system, accessible by a user through a user device, to receive a selection input from the user for modification of the background form; receive the selection input from the user interface; and modify the background form based on the selection input. The printing system includes a digital rear end module coupled to the processor. The digital rear end module is configured to: merge the modified background form with the input document to generate a print document.

According to further aspects illustrated herein, a non-transitory computer-readable medium implementing the subject matter includes instructions executable by a processing resource. The instructions are executed to: receive, at a printing system, a print job from a user device accessible by a user, wherein the print job comprising the input document; decompose the print job to determine whether the background form is selected by the user for modification; based on determination, extract the background form stored at the printing system; receive a selection input from a user interface of the printing system accessible by the user through the user device; modify the background form based on the selection input; and merge the modified background form with the input document to generate a print document.

Other and further aspects and features of the present subject matter will be evident from the following detailed description of the exemplary implementations, which are intended to illustrate, not limit, the present subject matter.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates a schematic network printing environment for network printing, according to an example.

FIG. 2 illustrates a schematic of a printing system, according to an example.

FIGS. 3A-3K illustrate an operation of the printing system, according to an example.

FIG. 4 illustrates a network environment for operating the printing system.

FIG. 5 illustrates a method for operating the printing system, according to an example.

### DESCRIPTION

A few aspects of the present subject matter are explained in detail below with reference to the various figures. Example implementations are described to illustrate the disclosed subject matter, not to limit its scope, which is defined by the claims. Those of ordinary skill in the art will recognize a number of equivalent variations of the various features provided in the description that follows.

### Non-Limiting Definitions

In the disclosure herein after, one or more terms are used to describe various aspects of the present subject matter. For better understanding of the subject matter, a few definitions are provided herein for better understating of the present disclosure.

“Input document” refers to a document transmitted from a user device or a client device to a network printer for printing. The input document is transmitted in the form of page description language (PDL) document such as PostScript (PS), Portable Document Format (PDF) and Extensible Markup Language (XML) Paper Specification (XPS). The input document includes a user specific data which is to be overlaid on predetermined areas within a static template of a background form.

“Background form” or “Background raster form” refers to a document stored in raster format on a print server. On the background form, the input document is imposed or overlaid in the predetermined areas defined by the static template of the background form. Further, the static template may represent the predetermined area in such a way that the input document fits in a layout of a physical printed document. Furthermore, for the sake of brevity, it can be appreciated by those skilled in the art that the background form described herein does not include digital watermarks in the context of the present disclosure.

“Region of interest” refers to a boundary of a region selected by a user on an image. The boundary may enclose characters, words, and text as well as other features such as graphics.

“Object types” refers one or more types of object which the user wishes to retain in the background form. Examples of the object types may include text, image, or graphics. “Image” is a representation of an electronic document by way of a pattern of physical light. The image may include characters, words, and text as well as other features such as graphics. The text may be included in a set of one or more images. The text may refer to portions of a document or image containing letters, numbers, or other symbols including non-alphabetic linguistic characters.

“Printing system” may be defined as including, but not necessarily limited to, a computing device, program, or combination thereof that processes requests, delivers data or other information, or provides one or more services over the cloud and/or a local network. In the context of the current disclosure, the printing system implements the functionality of merging the input document on the modified background form or associated tasks to achieve the same. The printing system may interchangeably be used with the phrase print server or print server application.

“Client device or user device” is defined as including, but not necessarily limited to, hardware, software, or a combination thereof that accesses a server. Examples include, but are not limited to, a computing device, phone, tablet, personal digital assistant, or server.

“Printer” may be defined as including, but not necessarily limited to, a peripheral that produces a representation of a document on one or both sides of media such as paper, transparency, fabric, etc. The printer can be single function device or multi-function (e.g., including scanning, faxing, or other functionality) device. The multi-function device may include software, hardware, firmware, or combination thereof. Further, the printer can use any of a variety of different types of marking technologies such as laser, inkjet, dye-sublimation, off-set printing, thermal printing, impact, etc. As used herein, the terms “render” and “rendering” are defined as including, but not necessarily limited to, taking print data such as text, images, graphics, etc., and converting them into a ready to print (RTP) format that is compatible with a destination printer.

“Computer-readable medium” or “storage medium” may be a physical medium that can store data. Examples of “computer-readable medium” may include magnetic medium such as diskettes, floppy disks, and tape; optical medium such as laser disks and CD-ROMs; and semiconductor medium such as semiconductor ROMs and RAMs. As used herein, “storage medium” covers one or more distinct units of a medium that together store a body of data. For example, a set of floppy disks storing a single body of data would together be storage medium.

### Overview

Several attempts have been made in the past to cater the emerging requirement of customizing background forms in the automated workflow processes of the printing systems. One such attempt focuses on editing a Page Description Language (PDL) document as per user's choice, saving the edited PDL as the background form, and then merging this modified background form with an incoming PDL document having input document. Evidently, such attempt involves huge manual effort, and may consume a lot of time.

Various method(s) and system(s) of the present subject matter described herein allow a user to modify a background form for network printing. In one example, a user of a user device (or a client device) may access a web portal for submitting a print job with a printing system. The web portal may be accessed, for example, by executing a web application or by accessing a uniform resource location (URL) address through a web browser. The web portal may present a user interface, such as a print dialogue box or a graphical user interface (GUI), which allows the user to submit an input document to be printed and various other print options including, but not limited to, an option of modifying a background form stored at the printing system.

Upon submission of the print options, the print job is transmitted to the printing system in the form of page description language (PDL) document such as PostScript (PS), Portable Document Format (PDF) and Extensible Markup Language (XML) Paper Specification (XPS). The PDL document may include information about fonts, graphics, and the like that describe the appearance of the input document present within the print jobs, and include a set of programming language commands or specifications for processing the input document based on the information. In one example, the PDL document may include information on whether a modification option for the background form is selected by the user or not.

Further, based on the commands present in the PDL document, the printing system decomposes the PDL document to determine whether the modification option for the background form is selected by the user. In case it is determined that the modification option is selected, the printing system extracts the background form which is selected for modification or printing by the user and present the same in the user interface of printing service at the user device accessible by the user.

The user then provides selection input on the background form presented at the user interface of the printing service accessible by the user device and submits the selection input with the printing system. In one example, the selection input may include selection of one or more region of interests in the background form presented in the user interface of the printing service. In another example, the selection input may include selection of one or more object types, for example, text, image, or graphics.

Based on the received selection input, the printing system performs modification of the background form by coping content of background raster buffer of the entire background form into a fabricated background raster buffer. In one example, the background form is already stored in a raster format in the background raster buffer at the printing system. Example of raster format may include, but not limited to, JPEG, TIFF, RAW, PNG, GIF, BMP, PPM, PGM, PBM, XBM, ILBM, WBMP, and PNM.

After copying the content into the fabricated background raster buffer, the printing system retains pixel values in ON state, for pixels present in the selected region of interests or for pixels associated with the selected object types, and converts pixel values to OFF state for pixels present outside the selected region of interests or for pixels not associated with the selected object types.

For better understanding of the disclosure, the terms are described. Input raster buffer is a rasterized buffer of an input document. The term fabricated raster buffer is a rasterized buffer of background form having only the user's selection or choice. In other words, the fabricated raster buffer is rasterized buffer of modified background form having only the one or more region or interests. Merge raster buffer is a rasterized buffer of a merged document. Additionally, the term background raster buffer is a rasterized buffer of a background form.

### Exemplary Implementations

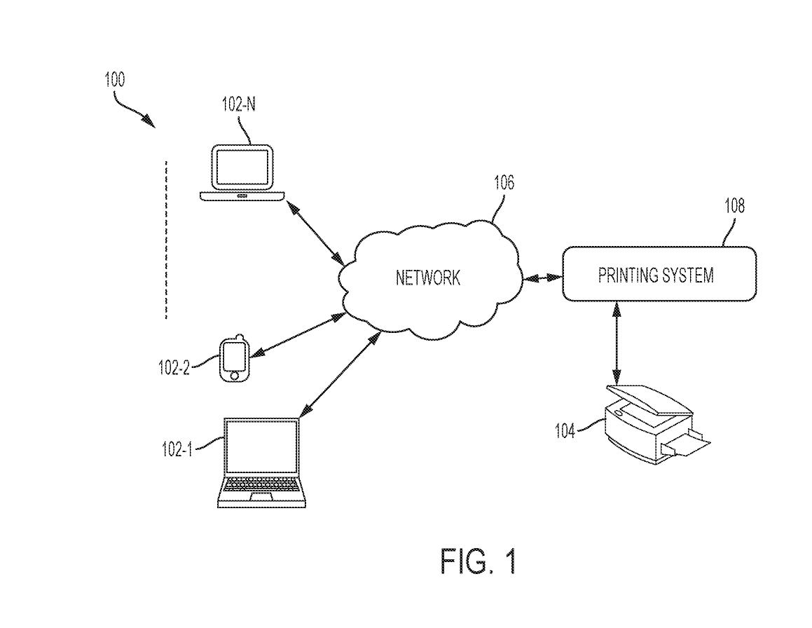

The following disclosure explains a mechanism where a printing system, with some hardware and software enhancements, is enabled to facilitate a user of a user device (or client device) to fabricate a new rasterized buffer of modified background form in order to support some sophisticated applications associated with personal, business, or administrative implementations. Such printing system is further described with reference to FIGS. 1-5.

It should be noted that the description and the figures merely illustrate the principles of the present subject matter along with examples described herein, and should not be construed as a limitation to the present subject matter. It is, thus, understood that various arrangements may be devised that, although not explicitly described or shown herein, embody the principles of the present subject matter. Moreover, all the statements herein reciting principles, aspects, and implementations of the present subject matter, as well as specific examples thereof, are intended to encompass equivalents thereof.

FIG. 1 illustrates, as an example, a network printing environment 100 for network printing of electronic documents, according to an example of the present subject matter. The network printing environment 100 includes a plurality of user devices 102-1, 102-2, . . . , 102-N, hereinafter collectively referred to as user devices 102 and individually as user device 102. Examples of the user devices 102 may include, but are not limited to, workstations, personal computers, personal digital assistants (PDAs), laptop computers, notebooks, smart phones, smart cameras, smart television sets, and other smart devices.

Further, the network printing environment 100 can include a plurality of network printers out of which one network printer 104 is shown for the sake of simplicity. In an example, the network printer 104 and the user devices 102 are connected over a network 106 through a printing system 108 via wired, wireless, optical, or other types of network connections.

The network 106 may be a single network or a combination of multiple networks. The network 106 may include one or more area networks, such as a local area network (LAN), a wide area network (WAN), an intranet, the internet, or any other type of network. In an example, the network 106 may include mobile communication network, for example, 2G, 3G or 4G mobile communication network.

In an example, a user of the user device 102-2 logins to a network printing service offered by the printing system 108. The user can login from the user device 102-2 present anywhere in the network 106, for submission of a print job to the printing system 108. Further, for submission of the print job, the user device 102-2 can facilitate the user to access a web portal of the network printing service. In an example, the user may access the web portal by selecting a print command for printing an input document. In another example, the user may access the web portal by directly entering a URL address of the web portal in a web browser. In yet another example, the user may access the web portal using other web elements, such as widgets, and web enabled applications. Further, the web portal may present a user interface, such as a print dialogue box, or a graphical user interface (GUI). The user interface allows the user to provide various print options including, but not limited to, an option of modifying a background form stored in raster format at the printing system 108.

For the network printing service, the web portal for printing is managed by the printing system 108. In an example, the printing system 108 may be a print server, a network server, a web server, or a data server. The printing system 108 receives the print job from the user device 102-2 in the form of a page description language (PDL) document. The PDL document includes information about fonts, graphics, and the like that describes the appearance of the input document present within the print job, and includes a set of programming language commands or specifications for processing the input document based on the information. In one example, the PDL document may include information on whether a modification option for the background form is selected by the user or not.

Based on the commands and information stored in PDL document, the printing system 108 decomposes the PDL document to determine whether the modification option for the background form is selected by the user. In case it is determined that the modification option is selected, the printing system 108 extracts the background form and present the extracted background form in the user interface of the printing service provided by the printing system 108 that is accessible by the user through the user device 102-2.

The user then provides selection input on the background form present in the user interface of the printing service and submits the selection input with the printing system 108, which is managing the printing service. The selection input includes either the selection of one or more region of interests or the selection of one or more object types, which the user wants to retain in the background form. In one example, the region of interests may be understood as boundaries of regions selected by the user on the background form. The region of interests may enclose characters, words, and text as well as other features such as graphics. Further, examples of the object types may include text, image, or graphics.

Based on the received user selection, the printing system 108 performs modification of the background form by coping content of background raster buffer of the entire background form into a fabricated background raster buffer. In one example, the background form is already stored in a raster format in the background raster buffer at the printing system 108.

After copying the content into the fabricated background raster buffer, the printing system 108 modifies the fabricated background raster buffer. The printing system 108 modifies the fabricated background raster buffer in such a way that the pixel values of selected region of interests or the selected object types are retained in ON state, while the pixel values of rest of the background form are changed to OFF state.

Pixels are generally defined to be in ON state if they contain a pixel value greater than zero in any color plane, for example, cyan, magenta, yellow, and key (C, M, Y, K). And, pixels are defined to be in OFF state if they contain zero pixel value. It should be noted that the pixels may be designation of black/color as ON state and white as OFF state. This merely reflects the fact that most documents of interest have a black/color foreground and a white background. While the techniques of the present subject matter could be applied to negative images as well, the description herein is provided in terms of black on white.

Yet further, pixel values may be associated with tag information that classifies portions of an image according to object types. “Tag” may be understood as object identifier that can categorize or classify the objects present in a raster image of the document based on the types of objects. Examples of the object types may include text, image, or graphics.

Further, in one example implementation, while performing the modification to the fabricated background raster buffer, the printing system 108 may remove tag values associated with the pixels changed to OFF state or pixels not associated with selected object types.

Once the fabricated background raster buffer is modified, the printing system 108 decomposes the PDL document to obtain the input document data to be printed. The input document data is then rasterized to generate an input raster buffer. The input raster buffer is then merged with the fabricated background raster buffer to generate a merged raster buffer. The merged raster buffer is then converted into a ready-to-print (RTP) format and made available to the network printer 104 for printing purposes.

In this way, the modification of the background form stored at the printing system 108 can be performed by a user over the network 106 so as to cater the emerging special requirements of customizing the background form for various personal, business, or administrative implementations.

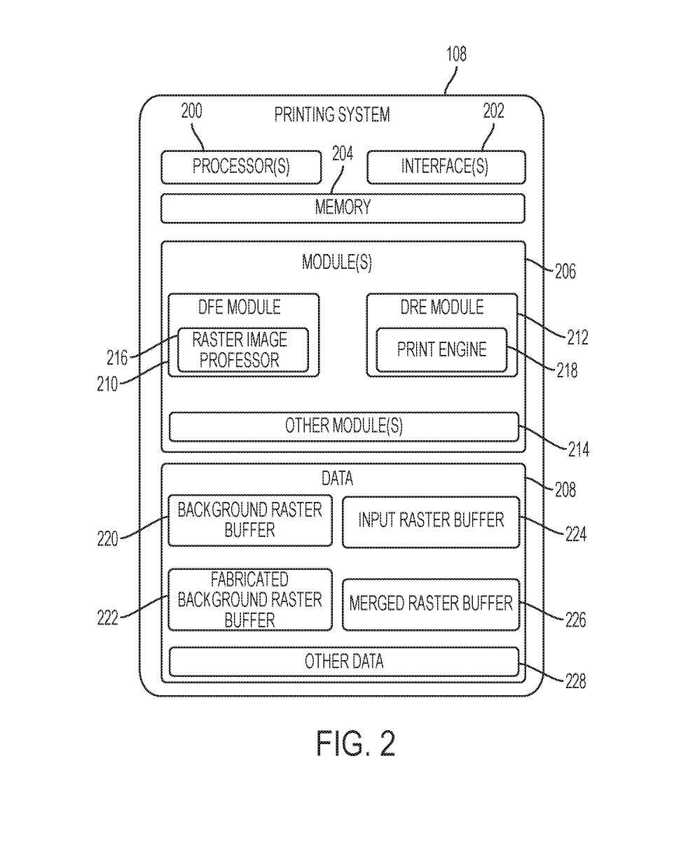

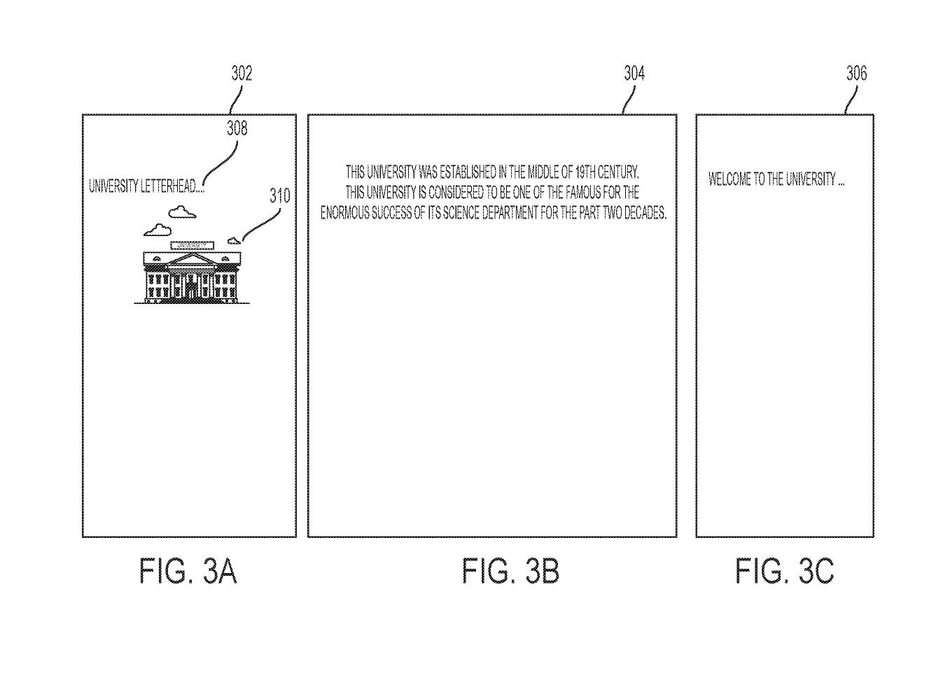

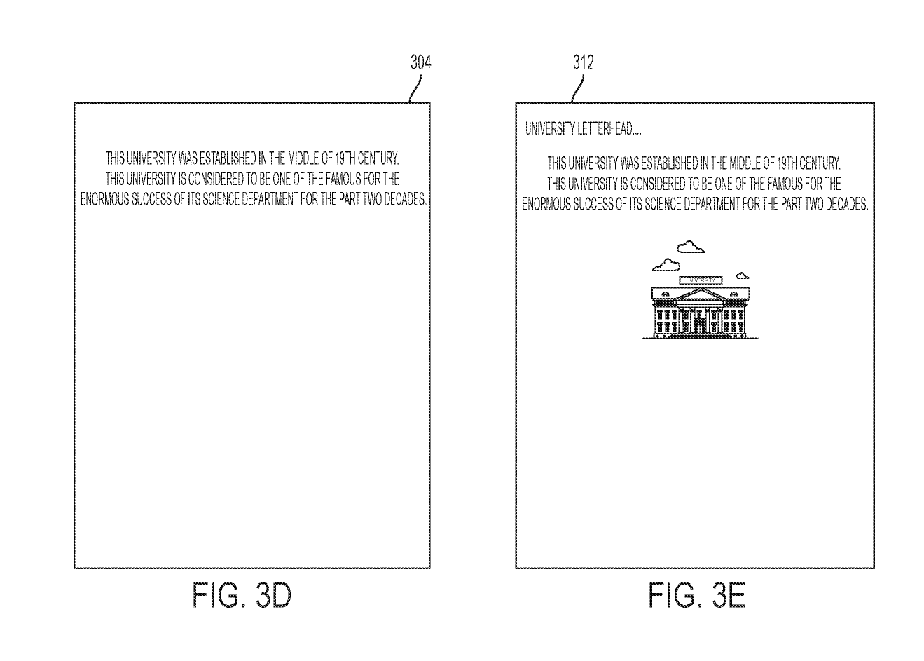

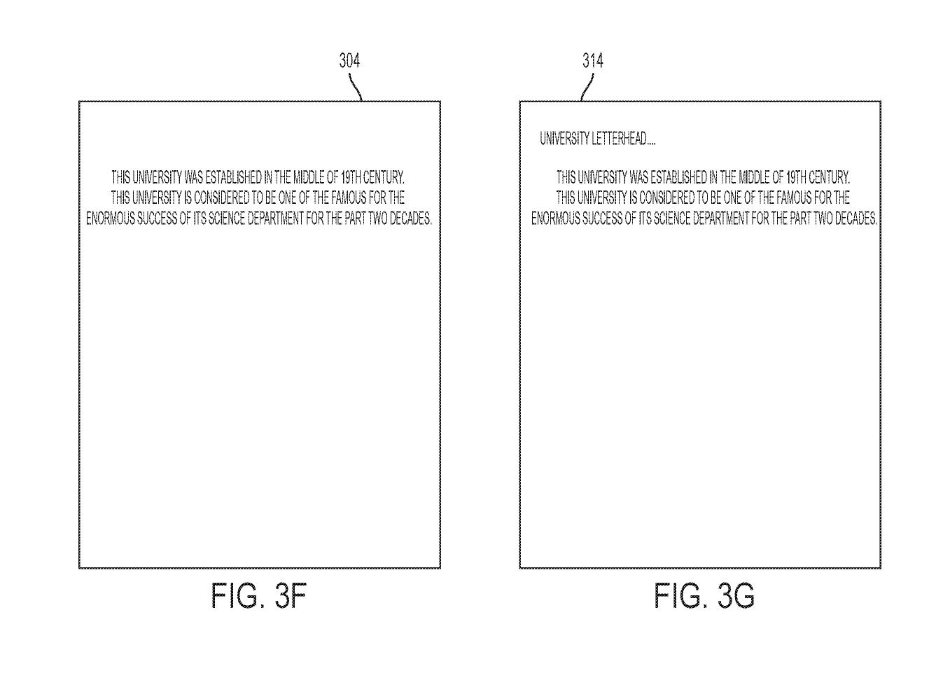

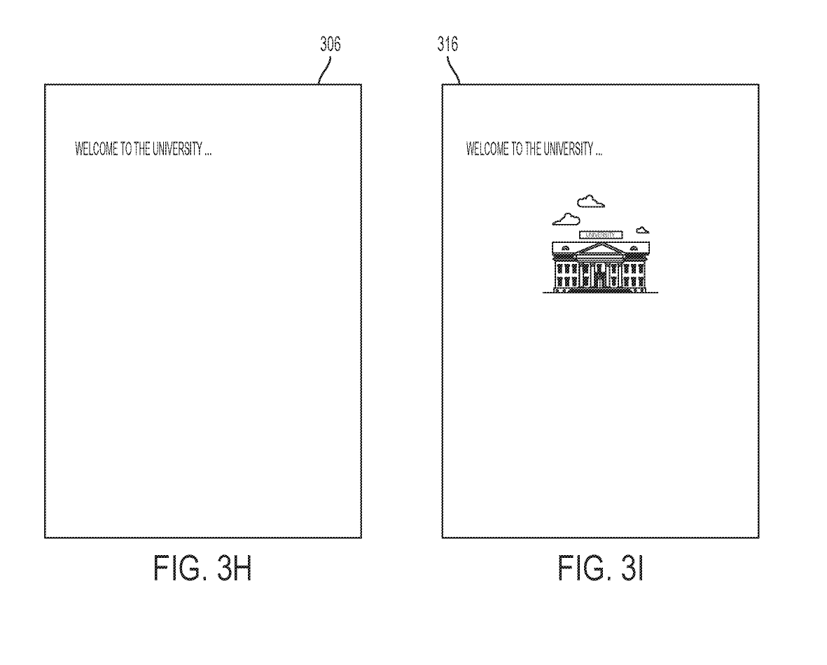

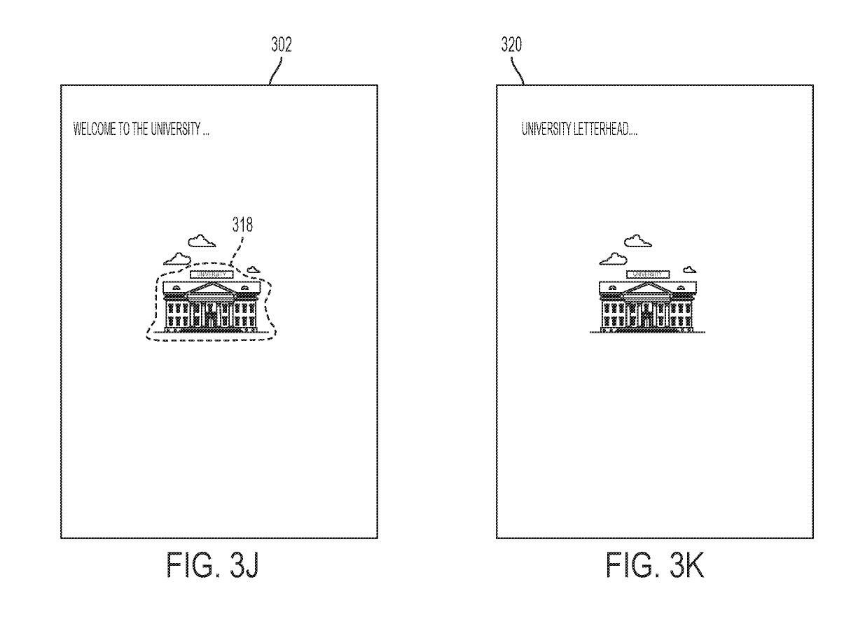

Further, in an example, the working of the printing system 108 implemented in the network printing environment 100, is described in more detail with reference to FIGS. 2 and 3A-3K.

FIG. 2 illustrates various components of the printing system 108, in accordance with one example of the present subject matter. The printing system 108 includes a processor 200, an interface 202, and a memory 204. Further, the printing system 108 includes module(s) 206 and data 208.

The processor 200, amongst other capabilities, may be configured to fetch and execute computer-readable instructions stored in the memory 204. The processor 200 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as processor(s), may be provided through the use of dedicated hardware as well as hardware capable of executing software in association with appropriate software.

When provided by the processor 200, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

The interface(s) 202 may include a variety of machine readable instructions-based interfaces and hardware interfaces that allow the printing system 108 to interact with different entities, such as the processor 200, the module(s) 206, and the data 208. Further, the interface(s) 202 may enable the components of the printing system 108 to communicate with other user segmenting systems, and external repositories. The interface 202 may facilitate multiple communications within a wide variety of networks and protocol types, including wireless networks, wireless Local Area Network (WLAN), RAN, satellite-based network, etc.

The memory 204 may be coupled to the processor 200 and may, among other capabilities, provide data and instructions for generating different requests. The memory 204 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The module(s) 206 may include routines, programs, objects, components, data structures, and the like, which perform particular tasks or implement particular abstract data types. The module(s) 206 may further include modules that supplement applications on printing system 108. Further, the module(s) 206 can be implemented in hardware, instructions executed by the processor 200, or by a combination thereof.

In one example, the module(s) 206 may be machine-readable instructions (software) which, when executed by a processor/processing unit, perform any of the described functionalities. The machine-readable instructions may be stored on an electronic memory device, hard disk, optical disk, or other machine-readable storage medium, or non-transitory medium. In one further example, the machine-readable instructions can also be downloaded to the storage medium via a network connection.

The module(s) 206 may perform different functionalities which may include, but may not be limited to, receiving a print job from the user device 102-2, decomposing the print job to determine whether a background form has been selected for modification by the user, extracting the background form stored in the background raster buffer of the printing system 108, presenting the background form at the user interface of the printing service accessible by the user through the user device 102-2, receiving a selection input from the user device 102-2 (the selection input including selection of one or more region of interests or selection of one or more object types in the background form presented on the user interface printing service accessible by the user through the user device 102-2), performing modification to the background form based on the user input, storing the modified background form in a fabricated background raster buffer, and merging the fabricated background raster buffer with an input raster buffer corresponding to the input document received within the print job. Accordingly, the module(s) 206 includes a digital front end (DFE) module 210, a digital rear end (DRE) module 212, and other module(s) 214. In one example, the DFE module 210 includes a raster image processor (RIP) 216, and the DRE module 212 includes a print engine 218.

Further, the data 208 serves, amongst other things, as a repository for storing data that may be fetched, processed, received, or generated by one or more of the module(s) 206. The data 208 further includes a background raster buffer 220, a fabricated background raster buffer 222, an input raster buffer 224, and a merged raster buffer 226, and other data 228. The other data 228 may include intermediate processing data related to image processing.

In operation, the DFE module 210 of the printing system 108 receives the incoming print jobs in the form of page description language (PDL) document such as PostScript (PS), Portable Document Format (PDF) and Extensible Markup Language (XML) Paper Specification (XPS). The PDL document may include information about fonts, graphics, and the like that describe the appearance of an input document present within the print job, and include a set of programming language commands for processing the input document based on the information. Also, in one example, the PDL document may include information on whether a modification option for a background form has been selected by the user or not.

Further, in an example, the commands stored in the PDL document are used to generate and register tag information on a per-pixel level in an image buffer based on an object type of the document data derived from the PDL document. Pixel level image data tagging is generally useful to differentiate between bit maps, text, line art, graphics (including fills and sweeps), and images in gray scale, RGB (Red Green Blue), CMYK (Cyan, Magenta, Yellow, and Key (Black)) and other color space frame buffers to enable per-pixel tags.

Returning to the present subject matter, once the print job is received in the form of PDL document, the DFE module 210 decomposes the PDL document to determine whether the modification option for the background form is selected by the user. In case it is determined that the modification option is selected, the DFE module 210 extracts the background form stored in raster format from the background raster buffer 222 and present the background form in the user interface of the printing service accessible by the user through the user device 102-2.

In one example, the background form may be received by the printing system 108 from the user device 102-2 in the form of PDL document before the receipt of the print job including the input document. In other words, the user of the user device 102-2 may first submit any print job that needs to be saved in the printing system 108 as the background form, and then the user submits another print job (input document) that is intended to be imposed on the previous job (background form).

In an alternate example, the user can select a background form from a list of all available background forms while submitting the print job in the user interface of the network printing service.

Continuing with the present subject matter, once the selected background form (for modification) is presented in the user interface, the user provides the selection input on the background form present in the user interface using an input device (not shown in figures). Examples of input device may include, but not limited to, touch screen, keyboard, mouse, touch pen, and the like.

In one example, the selection input includes the selection of one or more object types which the user wants to retain in the background form. Examples of the one or more object types may include text, image, or graphics.

In another example the selection input may include the selection of a region of interest in the background form. The region of interest is a region selected by the user on the background form. The region of interest may include boundary that may enclose characters, words, text, images as well as other features such as graphics.

Further, once the selection input is submitted by the user, the selection input is received by the DFE module 210 of the printing system 108. Based on the selection input, the DFE module 210 performs modification to the background form. For example, the DFE module 210 copies content of the background raster buffer 220 of the entire background form into the fabricated background raster buffer 222. In one example, the background form is already present in a raster format in the background raster buffer 220 at the printing system 108.

After copying the content into the fabricated background raster buffer 222, the DFE module 210 modifies the fabricated background raster buffer 222. The DFE module 210 modifies the fabricated background raster buffer 222 in such a way that the pixel values of selected region of interests or the selected object types are retained in ON state, while the pixel values of rest of the background form are changed to OFF state.

Once the modification of the fabricated background raster buffer 222 is performed, the DFE module 210 invokes the raster image processor 216 to perform raster image processing on the input document received within the PDL document for printing on the modified background form. For the raster image processing, the raster image processor 216 decomposes the PDL document to obtain the input document to be printed. The input document is then rasterized by the raster image processor 216 to generate the input raster buffer 224. In one example, the input raster buffer 224 may include pixel display values or pixel values arranged in raster format. Example of raster formats may include, but not limited to, JPEG, TIFF, RAW, PNG, GIF, BMP, PPM, PGM, PBM, XBM, ILBM, WBMP, and PNM. The fabricated background buffer 222 that is generated by the raster image processor 216 is immediately consumed by the DRE module 212, without a step of generating ready-to-print (RTP) objects and saving them on an intermediate storage for further processing. The DRE module 212 merges the fabricated background buffer 222 with the fabricated background raster buffer 222 corresponding to the modified background form, already available with printing system 108, to generate the merged raster buffer 226.

Once the merged raster buffer 226 is generated, the DRE module 212 calls the print engine 218. The print engine 218 then converts the merged raster buffer 226 into a ready-to-print (RTP) format. The converted merged raster data is either stored on the printing system 108 for processing or is provided to the network printer 104 for printing purpose.

The operation of the printing system 108 is described hereinafter in detail with reference to FIGS. 3A-3F.

FIG. 3A illustrates an example of a background form 302 on which either a first input document 304 (FIG. 3B) or a second input document 306 (FIG. 3C) is to be imposed during the printing. As shown, the background form 302 includes at least two object types, i.e., a text object type 308 and an image object type 310.

In an example shown in FIGS. 3D and 3E, it is considered that the user has selected that the background form 302 is not to be modified and merged with the first input document 304. Then the DFE module 210 may not perform any modification to the background form 302 and invokes the DRE module 212. The DRE module 212 then merges the first input document 304 with the non-modified or original background form 302, and outputs a merged document 312 (FIG. 3E).

In another example shown in FIGS. 3F and 3G, it is considered that the user selects the background form 302 is to be modified. To this end, the user provides a selection input, in which the user selects the text object type 308 of the background form 302 for merging with the first input document 304. With this selection input, the DFE module 210 modifies the background form 302 by retaining the selected text object type 308 and removing the other object types, and calls the DRE module 212 to merge the first input document 304 with the modified background form 302, and outputs a merged document 314 (FIG. 3G).

In yet another example shown in FIGS. 3H and 31, it is considered that the user selects the background form 302 for modification. To this end, the user provides a selection input, in which the user has selects the image object type 310 of the background form 302 for merging with the second input document 306. With this selection input, the DFE module 210 modifies the background form 302 by retaining the selected image object type 310 and removing the other object types, and calls the DRE module 212 to merge the second input document 306 with the modified background form 302, and outputs a merged document 316 (FIG. 31).

In yet another example shown in FIGS. 3J and 3K, it is considered that the user wishes to modify the background form 302. Here, the user provides a selection input, in which the user selects a region of interest 318 (FIG. 3J) in the image object type 310 of the background form 302 for merging with the input document 304 or 306. With this selection input, the DFE module 210 modifies the background form 302 by retaining the selected region of interest 318 from the image object type 310 in the background form 302 and other regions not selected by the user are removed from the background form 302. The DRE module 212 merges the second input document 306 with the modified background form 302, and outputs a merged document 320 (FIG. 3K)

Thus, with the implementation of the present subject matter, a user is able to modify the background form 302 stored at or provided to the printing system 108, so as to cater the emerging special requirements of customizing the background form 302 before merging with the input document for various personal, business, or administrative implementations.

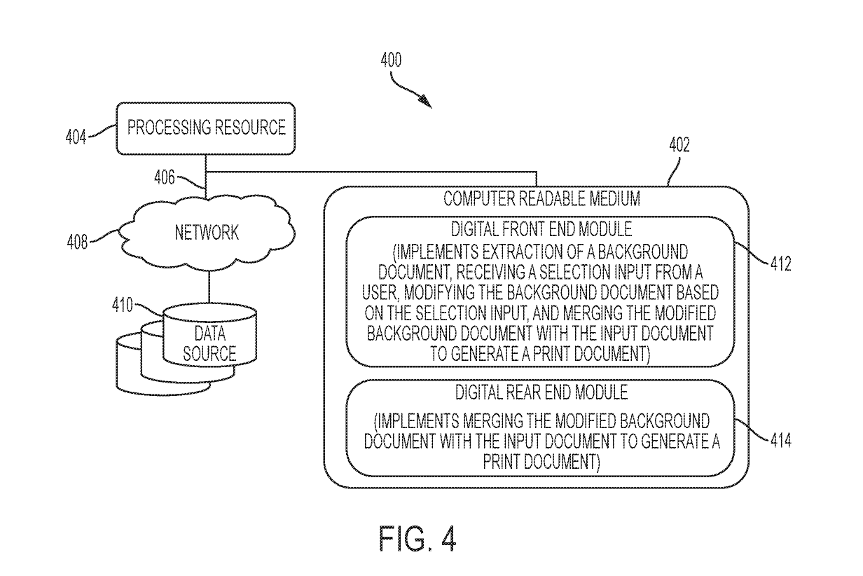

FIG. 4 illustrates an example network environment 400 using a non-transitory computer readable medium 402 for stalling operation of the printing system 108, according to an example of the present subject matter. The network environment 400 may be a public networking environment or a private networking environment. In one example, the network environment 400 includes a processing resource 404 communicatively coupled to the non-transitory computer readable medium 402 through a communication link 406.

For example, the processing resource 404 can be a processor, such as the control device of the printing system 108. The non-transitory computer readable medium 402 can be, for example, an internal memory device or an external memory device. In one example, the communication link 406 may be a direct communication link, such as one formed through a memory read/write interface. In another example, the communication link 406 may be an indirect communication link, such as one formed through a network interface. In such a case, the processing resource 404 can access the non-transitory computer readable medium 402 through a network 408. The network 408 may be a single network or a combination of multiple networks and may use a variety of communication protocols.

The processing resource 404 and the non-transitory computer readable medium 402 may also be communicatively coupled to data sources 410 over the network 408. The data sources 410 can include, for example, databases and computing devices. The data sources 410 may be used by the database administrators and other users to communicate with the processing resource 404.

In one example, the non-transitory computer readable medium 402 can include a set of computer readable instructions, such as a digital front end (DFE) module 412 and a digital rear end (DRE) module 414. The set of computer readable instructions, referred to as instructions hereinafter, can be accessed by the processing resource 404 through the communication link 406 and subsequently executed to perform acts for network service insertion. In other words, during operation, the processing resource 404 can execute the DFE module 412 and DRE module 414.

On execution by the processing resource 404, the DFE module 412 receives a print job in the form of page description language (PDL) document. The PDL document may include information about fonts, graphics, and the like that describe the appearance of an input document present within the print job, and include a set of programming language commands for processing the input document based on the information. In one example, the PDL document may include information on whether a modification option for a background form has been selected by the user or not.

Further, based on the commands present in the PDL document, the DFE module 412 decomposes the PDL document to determine whether the modification option for the background form is selected by the user. In case it is determined that the modification option is selected, the DFE module 412 extracts the background form and present the background form in the user interface of the printing service accessible by the user through the user device 102-2. In one example, the background form is already stored in a raster format in the background raster buffer 220 at the printing system 108. In another example, the user may have submitted the background form in the form of PDL document before submission of the present print job.

In one example, the user may provide a selection input on the background form present in the user interface using an input device (not shown in figures). Examples of input device may include, but not limited to, touchscreen, keyboard, mouse, touch pen, and the like. The selection input may include either the selection of one or more region of interests or the selection of one or more object types, which the user wants to retain in the background form.

Further, the selection input is submitted to the DFE module 412. Based on the selection input, the DFE module 412 performs modification to the background form. For example, the DFE module 412 may copy content of the background raster buffer 220 of the entire background form into the fabricated background raster buffer 222. After copying the content into the fabricated background raster buffer 222, the DFE module 412 modifies the fabricated background raster buffer 222. The DFE module 412 modifies the fabricated background raster buffer 222 in such a way that the pixel values of selected region of interests or the selected object types are retained in ON state, while the pixel values of rest of the background form are changed to OFF state.

Further, once the modification of the fabricated background raster buffer 222 is performed, the fabricated background buffer 222 is then received by the DRE module 414. The DRE module 414 merges the fabricated background buffer 222 with the input raster buffer 222, corresponding to the input document received with a print job, to generate a merged raster buffer 226

Once the merged raster buffer 226 is generated, the DRE module 414 converts the merged raster buffer 226 into a ready-to-print (RTP) format. The converted merged raster buffer 226 is then either stored on the printing system 108 for processing or is provided to the network printer 104 for printing purpose.

In this way, the present subject matter allows a user to modify the available background form in accordance with a specific choice, so as to cater the emerging specific requirements of customizing the background form for various personal, business, or administrative implementations.

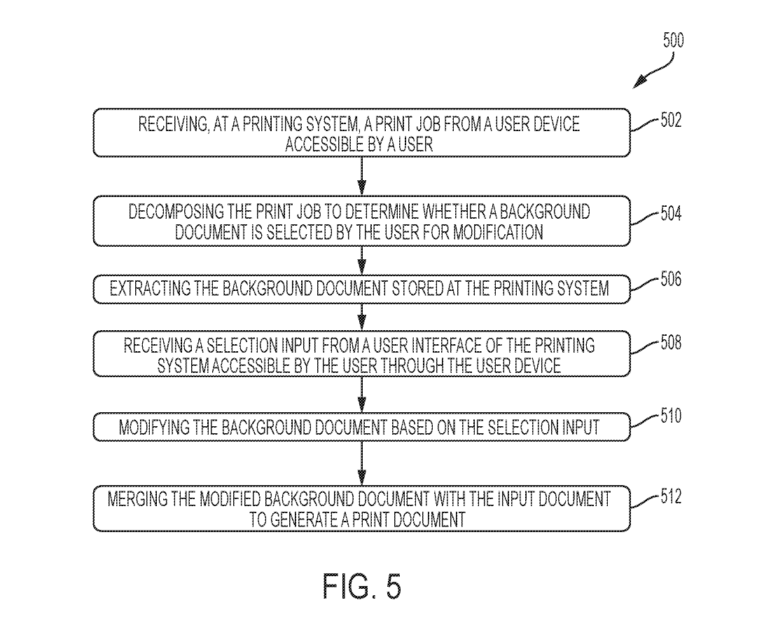

Method 500 is described in FIG. 5 for operating the printing system 108, according to an example of the present subject matter. The order in which the method 500 is described is not intended to be construed as a limitation, and any number of the described method blocks can be combined in any appropriate order to carry out the method 500 or an alternative method. Additionally, individual blocks may be deleted from the method 500 without departing from the scope of the subject matter described herein.

The method 500 can be performed by programmed computing devices, for example, based on instructions retrieved from the non-transitory computer readable medium or non-transitory computer readable media. The computer readable media can include machine-executable or computer-executable instructions to perform all or portions of the described method. The computer readable media may be, for example, digital memories, magnetic storage media, such as a magnetic disks and magnetic tapes, hard drives, or optically readable data storage media.

Referring to FIG. 5, the method 500 may be performed by a processing device, such as the processor 200 of the printing system 108.

At block 502, the printing system 108 receives a print job from a user device, say user device 102-2. The print job is received in the form of page description language (PDL) document. The PDL document may include information about fonts, graphics, and the like that describe the appearance of input document data present within the print job, and include a set of programming language commands for processing the input document data based on the information. In one example, the PDL document may include information on whether a modification option for the background form has been selected by the user or not.

At block 504, the received print job is decomposed to determine whether the modification option for the background form is selected by the user.

At block 506, the printing system 108 extracts the background form, in case it is determined that the modification option for the background form is selected by the user while submitting the print job.

At block 508, the extracted background form is presented in the user interface of the printing service accessible by the user through the user device 102-2 to receive selection input. Once the user provides the selection input, the printing system 108 receives the selection input. In an example, the selection input may include either the selection of one or more region of interests or the selection of one or more object types, which the user wants to retain in the background form.

At block 510, the printing system 108 performs modification to the background form based on the selection input. For example, the printing system 108 copies content of the background raster buffer 220 of the entire background form into the fabricated background raster buffer 222. In one example, the background form is already stored in a raster format in the background raster buffer 220 at the printing system 108. After copying the content into the fabricated background raster buffer 222, the printing system 108 modifies the fabricated background raster buffer 222. The printing system 108 modifies the fabricated background raster buffer 222 in such a way that the pixel values of selected region of interests or the selected object types are retained in ON state, while the pixel values of rest of the background form are changed to OFF state.

At block 512, upon modification, the modified background form is merged with the input document received within the print job to generate a print document.

Thus, with the implementation of the present subject matter, the modification of the background forms or background raster forms stored at the printing system 108 can be performed by a user over the network 106 so as to cater the emerging requirement of customizing the background form for personal, business, or administrative implementations.

For a person skilled in the art it is understood that the printing system should not be mixed with the phrase printer. The printing system refers to an application that performs the function of modifying and merging modified background form with an input document as discussed above in detail, while the printer receives the modified document and prints the document. The printing system may be a part of the printer while the printing system may be separately located or remotely located from the printer.

Further, the present subject matter is disclosed herein with reference to a server-client architecture; however, the subject matter is equally applicable to printing systems implemented in multi-functional devices, such as printers, copiers, and the like, which are in direct communication with the user devices.

For a person skilled in the art, it is understood that the use of phrase(s) “is,” “are,” “may,” “can,” “could,” “will,” “should,” or the like is for understanding various embodiments of the present disclosure and the phrases do not limit the disclosure or its implementation in any manner.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “merging,” or “decomposing,” or “extracting,” or “modifying,” or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for merging an input document on a modified background form, comprising:
receiving, at a printing system, a print job from a user device accessible by a user, wherein the print job comprising the input document;
decomposing the print job to determine whether an option for modifying a background form is selected by the user;
based on determination, extracting the background form stored at the printing system;
receiving a selection input for modifying the background form via a user interface of the printing system accessible by the user through the user device;
modifying the background form based on the selection input, wherein the selection input comprises: selection of one or more region of interests or selection of one or more object types, in the background form; and
merging the modified background form with the input document to generate a print document.

2. (canceled)

3. The method as claimed in claim 1, wherein the modifying comprises retaining pixel values of pixels present in the selected region of interests in ON state, while changing pixel values of pixels present outside the selected region of interests to OFF state.

4. The method as claimed in claim 1, wherein the modifying comprises removing tag values associated with pixels present outside the selected region of interests.

5. (canceled)

6. The method as claimed in claim 1, wherein the modifying comprises retaining pixel values of pixels associated with the selected one or more object types in ON state, while changing pixel values of pixels not associated with the selected one or more object types to OFF state.

7. The method as claimed in claim 1, wherein the modifying comprises removing tag values associated with pixels not associated with the selected one or more object types.

8. The method as claimed in claim 1, wherein the one or more object types comprise one of a text, image, and graphics.

9. The method as claimed in claim 1, further comprising:
performing raster image processing on the modified background form to generate a fabricated background raster buffer;
decomposing the print job to extract the input document from the received print job;
performing raster image processing on the input document to generate input raster buffer;
merging the input raster buffer with the fabricated background raster buffer, to generate a merged raster buffer; and
converting the merged raster buffer into a ready-to-print (RTP) format for generating the print document.

10. A printing system for merging an input document on a modified background form, comprising:
a processor;
a digital front end module, coupled to the processor, to:
receive a print job comprising the input document;
present a background form at a user interface, of the printing system, accessible by a user through a user device, to receive a selection input from the user for modification of the background form;
receive the selection input for modifying the background form via the user interface; and
modify the background form based on the selection input, wherein the selection input comprises: selection of one or more region of interests or selection of one or more object types, in the background form; and
a digital rear end module, coupled to the processor, to:
merge the modified background form with the input document to generate a print document.

11. (canceled)

12. The printing system as claimed in claim 10, wherein the digital front end module performs modification of the background form by retaining pixel values of pixels present in the selected region of interests in ON state, while changing pixel values of pixels present outside the selected region of interests to OFF state.

13. The printing system as claimed in claim 10, wherein the digital front end module performs modification of the background form by removing tag values associated with pixels present outside the selected region of interests.

14. (canceled)

15. The printing system as claimed in claim 10, wherein the digital front end module performs modification of the background form by retaining pixel values of pixels associated with the selected one or more object types in ON state, while changing pixel values of pixels not associated with the selected one or more object types to OFF state.

16. The printing system as claimed in claim 10, wherein the digital front end module performs modification of the background form by removing tag values associated with pixels not associated with the selected one or more object types.

17. The printing system as claimed in claim 10, wherein the one or more object types comprise one of a text, image, and graphics.

18. The printing system as claimed in claim 10, wherein the digital front end module comprises an image raster processor to:
perform raster image processing on the modified background form to generate a fabricated background raster buffer;
decompose the print job to extract the input document from the received print job; and
perform raster image processing on the input document to generate an input raster buffer.

19. The printing system as claimed in claim 18, further comprising a digital back end module to:
merge the input raster buffer with the fabricated background raster buffer, to generate a merged raster buffer; and
convert the merged raster buffer into a ready-to-print (RTP) format for generating the print document.

20. A non-transitory computer-readable medium comprising instructions executable by a processing resource to:
receive, at a printing system, a print job from a user device accessible by a user, wherein the print job comprising the input document;
decompose the print job to determine whether an option for modifying the background form is selected by the user;
based on determination, extract the background form stored at the printing system;
receive a selection input for modifying the background form via a user interface of the printing system accessible by the user through-the user device;
modify the background form based on the selection input, wherein the selection input comprises: selection of one or more region of interests or selection of one or more object types, in the background form; and
merge the modified background form with the input document to generate a print document.

21. The non-transitory computer-readable medium of claim 20 comprising instructions executable by the processing resource to:
perform raster image processing on the modified background form to generate a fabricated background raster buffer;
decompose the print job to extract the input document from the received print job;
perform raster image processing on the input document to generate input raster buffer;
merge the input raster buffer with the fabricated background raster buffer, to generate a merged raster buffer; and
convert the merged raster buffer into a ready-to-print (RTP) format for generating the print document.
